(19) United States
(12) Patent Application Publication
(10) Pub. No.: US 2024/0033158 A1
(43) Pub. Date: Feb. 1, 2024

(54) LOWER EXTREMITY EXOSKELETON WITH INTEGRATED POLES AND SIT TO STAND CHAIR

(71) Applicant: SKELETAL AXES ASSISTIVE ROBOTS INC., St. Petersburg, FL (US)

(72) Inventors: Boaz E. Eidelberg, Commack, NY (US); Thomas Pilock, Viera, FL (US); Jack Cheng Ji Zhu, Plainview, NY (US); John Deverdits, Franklin, MA (US); Sharyn M. Blau, Commack, NY (US)

(21) Appl. No.: 18/228,967

(22) Filed: Aug. 1, 2023

Related U.S. Application Data
(60) Provisional application No. 63/370,029, filed on Aug. 1, 2022.

(51) Int. Cl. A61H 1/02; A61G 5/14

(52) U.S. Cl. CPC A61H 1/0262; A61G 5/14; A61H 2201/165

(57) ABSTRACT

A four leg, lower extremity, robotic exoskeleton system is provided for medically assistive motion in gait, sit to stand (STS) and step climbing activities. The system has four articulated robotic legs, including two exoskeleton legs and two auto-pole legs, which are connected to a torso frame, controlled by a motion controller and a user interfaces, and that interacts with an assistive stationary robotic chair, or a wheelchair, for storage, dressing, STS and rest. The STS motion, in the stationary chair and the wheelchair, may be done with a single axis linear actuator, which maintains a back seat tip parallel to the ground for safety and comfort. Links of the exoskeleton and auto-pole legs are actuated by a linear or rotary actuators with their synchronized motion controlled by the motion controller, for safety, comfort and cost performance optimization depending on the medical needs.

### CROSS-REFERENCE TO RELATED APPLICATIONS

This application claims priority to U.S. Provisional Application No. 63/370,029, entitled: Lower Extremity Exoskeleton with Integrated Poles and STS Chair, filed on Aug. 1, 2022, the content of which is hereby incorporated by reference in its entirety.

### TECHNOLOGICAL FIELD

The present disclosure relates generally to assistive devices for improved mobility of handicapped people and, in particular, to a lower extremity exoskeleton with integrated poles and sit to stand (STS) chair.

### BACKGROUND

The world we live in has an average population growth rate of about 1% a year. With close to 8B people living in the world in 2020, the global growth rate amounts to a population increase of 80M per year. At the same time, life expectancy of elderly people may be continuously increasing. For example, between 2000 and 2019 the average life expectancy increased by 6 years to 73.4. As a result, less people are dying due to their disabilities. This trend implies that the number of elderly people, who are subjected to increased health problems, may be continuously increasing. A common health problem in old age may be immobility of people who suffer from arthritis, osteoporosis, stroke and Parkinson's disease. In 2019 CDC presented the following press release “The most common disability type, mobility, affects 1 in 7 adults. With age, disability becomes more common, affecting about 2 in 5 adults age 65 and older.”

Prolonged Immobility may further reduce the affected person's health condition, such as pneumonia, infection, thrombosis and ulcer, and further increase fatigue, low self-esteem and low confidence.

From these trends and observations, we may conclude, that there may be an increasing need to assist elderly people in preserving, assisting or regaining their mobility. Similarly, the need for assistive mobility exists for any person in the world, who's upper and/or lower limbs are not functional or limited in functionality. The reasons may be due to paralysis, spinal cord injury, or due to rehabilitation need in post-surgery, or recovery from wounds. These needs constitute a motivation of various example implementations of the present disclosure, which includes a novel four leg exoskeleton system with integrated poles to assist handicapped, immobile, people in their sit to stand (STS) and gait ability.

### BRIEF SUMMARY

Assistive devices for improved mobility of handicapped people include passive and active solutions. Typical passive devices include canes, poles, walkers and wheelchairs. Active devices include, among others, scooters, motorized wheelchairs, motorized chairs and robotic exoskeletons. Exoskeletons are kinematic linkages, which are connected to the user's human body with straps. The links of the exoskeleton are connected to one another with joints. Each joint may have 1 to 3 angular degrees of freedom, just like the human joints, including pitch, yaw and roll, or in a more complex robotic system may have additional 1 to 3 linear axis in X,Y,Z direction. Each degree of freedom may be actuated by a power generation device, such as electric motor, harmonic drive, worm wheel drive, or electric, pneumatic or hydraulic actuator. Actuators may include related levers that provide the controlled joint its required force and torque for the desired motion. The motion of powered devices may be typically controlled by a controller, which generates a desired synchronized motion among all the mechanism joints and receive sensors' feedback from the environment such as position, velocity, acceleration, force, image and voice. The integrated controller and the mechanism constitute a robot. Once the robot may be connected to the user's limbs, for a specific motion assist, it becomes a robotic exoskeleton. The control system could be based on any common control technology, such as Bang-Bang (on-off), which may be the simplest and most efficient, proportional-integral-derivative (PID) most common, Kalman filters for random environment, or fuzzy logic for nonlinear disturbances. In recent years Reinforcement Learning (RL), which uses Artificial Intelligence (AI) and Machine Learning (ML) technology, became popular to optimize robot performance under both nonlinear and uncertain, random environment, as common in exoskeletons. The output actions of a RL controller are based on input of sensed environment signals. The input signals are acting on hundreds of neural network (NN) parameters, which are being learnt based on assigned reward policy. The reward policy may be chosen to optimize the desired assistive action of the exoskeleton in a simulated environment. Once learnt in the simulated environment, the final NN parameters are being used as the exoskeleton motion controller. Example implementations of the present disclosure are designed for a variety of STS, gait and step climbing motions using Bang-Bang, PID and RL controllers with user's monitoring.

An objective of various example implementations of the present disclosure may be to present an exoskeleton system with one or more of the following improved characteristics:
1. Provide safe and comfort STS ability to a user with an exoskeleton and integrated poles;
2. Provide control system for a desired motion which best fits the user's handicap;
3. Improve rehabilitation of the user's lower limbs with multiple gait and STS options;
4. Improve the process of an independent dress and undress of the exoskeleton system;
5. Improve comfort level with integrated auto-poles, which free the user's hands;
6. Increase reliability, reduce maintenance, and lower weight with consistent low force short travel actuators and sensors by differentiating STS and gait ability;
7. Use RL for optimizing conflicting needs, such as minimum energy consumption, maximum accuracy, maximum comfort, maximum speed.
8. Provide Data communication to Clouds for monitoring training and rehabilitation progress;
9. Provide two-way communication between AI/ML tools in Clouds and exoskeletons to improve individual controller parameters based on input from many similar users; or
10. Provide an exoskeleton system which may be easy to learn at an affordable cost.

Meeting the specified needs, may be partially achieved by using a high-power robotic chair for STS motion, which requires high moment and high angular movement for the knee. The chair serves as a storage and automated charging location for the exoskeleton, ready for the user to comfortably sit down, dress up the exoskeleton, stand up and be ready to start the gait. Or, when coming back from a gait, to sit down, undress the exoskeleton, stand up independently, and possibly being supported by an assistant to reach out for the next destination. The independent chair, for STS motion, allows the exoskeleton to use smaller actuators for lower moments and lower angular displacement, as required for gait motion. The integrated poles, intended to provide increased safety and comfort, and the choice of sensors, transmitters and controllers provide the ability to store data, monitor progress and improve performance.

Exoskeletons have been in development since the late 19th century with interest to augment human mobility using gas bags. Development continued in the late 1910's using steam, which was not readily applicable. In the 1960's exoskeletons started to get military attention using hydraulic and electricity. But only when batteries became readily available that exoskeletons became a practical solution for military, industrial and healthcare applications. Today, since the early 21st century, there are several successful exoskeleton manufacturers, with commercially available products for military, industrial and medical applications. Their development was highlighted by innovative low weight, high stiffness, composite materials, miniaturization of electronic motors, sensors and controllers, high speed communication with global cloud services for Artificial Intelligence applications at affordable costs. Yet, professional reviewers are implying that the growing market of elderly and mobility handclapped needs are continuously growing with requirements for additional safety, higher comfort, lower weight, lower energy consumption, easier learning process and lower costs. Within the medical applications there are upper body and lower body wearable robotic systems, which are being used for assistive and rehabilitation purposes.

Typical present day, commercial, exoskeletons are provided for robot STS and gait motion, which require large size actuators and large joint angles for the combined motion. In addition, most prior art exoskeletons require the user to use poles which provide stability for a safe gait yet occupy the hands for handling the poles. Example implementations of the present disclosure improve on present day exoskeletons by an optional separating the gait motion from STS and reducing the carried exoskeleton weight. Example implementations also replace the hand poles by auto poles which provide safe motion balance yet frees the hands for other tasks. In addition, example implementations utilize AI/ML control technology with hundreds of NN parameters which may be optimized with proper dynamic modeling and reward functions to yield an optimal control for a desired gait cycle which best suit the handicap type. This allows an optimization of conflicting objectives such as maximum safety, minimum energy, maximum speed, maximum accuracy, and minimum strain. For simple rehabilitation applications, example implementations of the present disclosure may operate with simpler Bang, Bang (On/Off) controllers or the commonly used PID where common motion feedback of position, velocity and acceleration may be supplemented by numerous force sensors.

It may be therefore a motivation of example implementations of the present disclosure to develop an innovative medical exoskeleton system, using four robotic legs which are synchronized with a comfortable STS chair or a wheelchair. A system which may be controlled by an AI/ML, NN, and improves the capabilities of prior art, which does not have them. A solution which may adopt better to future complex standards of exoskeleton systems, that provide complex interaction between a handicapped human user and an assistive medical robot.

### BRIEF DESCRIPTION OF FIGURE(S)

Having thus described example implementations of the disclosure in general terms, reference will now be made to the accompanying figures, which are not necessarily drawn to scale, and wherein:

FIG. 1 presents the overall view of an example implementation of the present disclosure, including a robotic wheelchair with an assistive sit to stand (STS) mechanism, and a complementary exoskeleton with integrated auto-poles.

FIG. 2 shows a similar view as FIG. 1 with the wheelchair wheels removed, and foot plate added, converting it to an assistive STS robotic chair with small wheels to comfortably move it from place to place.

FIGS. 3A, 3B, 3C and 3D display the robotic chair in stand position, sit position, folded position, and the detailed 4 bar linkage for the STS mechanism respectively. The same STS mechanism may be used for both the robotic wheelchair, as presented in FIG. 1, and the robotic chair, as presented in FIG. 2.

FIG. 4 illustrates the exoskeleton with integrated auto-poles, showing the similarity of the drive and lock mechanisms of the exoskeleton legs and the auto-poles. The linear actuators may be replaced in some applications by direct drive rotary actuators.

FIG. 5 shows the details of the lock mechanisms for the auto-poles and the legs, including a kinematic diagram of a 4-bar linkage that includes two leg links, an actuator and a lock link.

FIG. 6 illustrates a user wearing the exoskeleton in stand and sit positions.

FIG. 7, including FIGS. 7A, 7B, 7C, 7D and 7E, demonstrates the independent sitting and standing process of a handicap user, where assistance may be needed before sitting and after standing, when the user may be not wearing the exoskeleton.

FIG. 8 illustrates a gait option, where only the hips are actuated with shanks being kept straight with the thighs. As shown, when one pole and one leg are stationary the other leg and pole are in swing mode.

FIG. 9 shows a gait cycle where both thighs and shanks are being actuated, where only one element, a leg or an auto-pole, may be in a swing mode while the other three elements are in a supporting stance mode.

FIG. 10A illustrates a gait option, where the two auto-poles are always stationary, when one leg may be in a swing mode, and the two auto-poles (legs) are in swing mode when the two (exoskeleton) legs are in a stance mode.

FIG. 10B illustrates a step climbing motion, which may follow a gait as shown in FIG. 10A. As shown the two auto pole legs serve as a balancing back support when each of the exoskeleton legs climbs the step.

FIG. 10C shows downstairs motion. The exoskeleton legs bend with the torso leaning forward. The auto-pole legs pitch forward and engage the lower step. With two auto pole legs and one exoskeleton foot serving as a balancing support, one of the exoskeleton leg moves down the step, followed by the second leg.

FIG. 11 shows an electrical block diagram of the exoskeleton and the robotic chair systems.

FIG. 12 illustrates a Bang-Bang motion control block diagram. This control system requires the least amount of energy at the expense of a lower accuracy. The diagram shows two sections, Planning and Application. Planning may be used for formulation of the desired gait profile, which may then serve as an input to the actual Application.

FIG. 13 shows a PID block diagram, which may be the most common control method in automation. The diagram shows two sections, Planning and Application, similar to FIG. 12.

FIG. 14 shows a RL block diagram. RL may be a more complex control system used for nonlinear and random environment, as expected in exoskeletons. The first section of the diagram may be the Planning phase, as described in FIGS. 12 and 13, providing a desired reference kinematic profile for the selected gait. The second section may be a dynamic RL model, which simulates the exoskeleton system, including the user's, exoskeleton and auto-poles inertia with random and nonlinear disturbances from the user. The objective of this section may be to optimize a Neural Network (NN) controller for maximum rewards. The third section uses the optimal NN controller, which was found in the second section. The optimal NN controller acts like a PID controller, yet with hundreds of optimized parameters and many input state signals rather than the 3 parameters of a PID controller with a few position and velocity feedback signals.

FIG. 15 shows the electrical control system of the robotic chair as a standalone product.

FIG. 16A shows the RL block diagram of the robotic STS chair.

FIG. 16B shows examples of the safe and slip best fit force curves of use in the reward function of the robotic STS chair.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form.

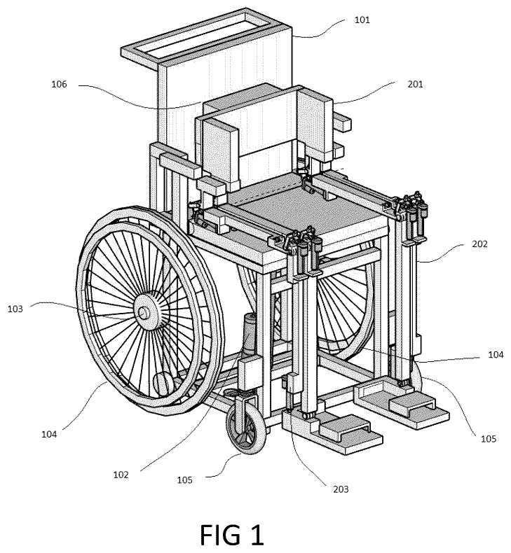

FIG. 1 presents the overall view of an example implementation of the present disclosure, including a robotic wheelchair (101) with an assistive sit to stand/stand to sit (STS) mechanism (102). The rear wheels (104) may be activated by the user's hand or by a motor (103) which includes an integrated brake to stop motion and resist it when stationary. Rotation may be achieved by rotating the rear wheels (104) in opposite directions. The front wheels (105) are idle casters and may follow the induced motion by the rear wheels (104). The wheelchair (101) has a complementary exoskeleton (201) with integrated auto-poles (202, 203), which are shown in a sit position ready for a user to sit down, wear it, stand up and use it for an assistive gait motion. Motion of the wheelchair (101), the exoskeleton (201), and the auto-poles (202, 203) may be controlled by an electrical system within the control box (106) with wire and wireless communication. The wheels of the wheelchair (104, 105) are removable and may be disconnected from their battery power supply which may be located in the electronic box (106). When the wheelchair wheels (104, 105) are disconnected the wheelchair becomes a stationary chair.

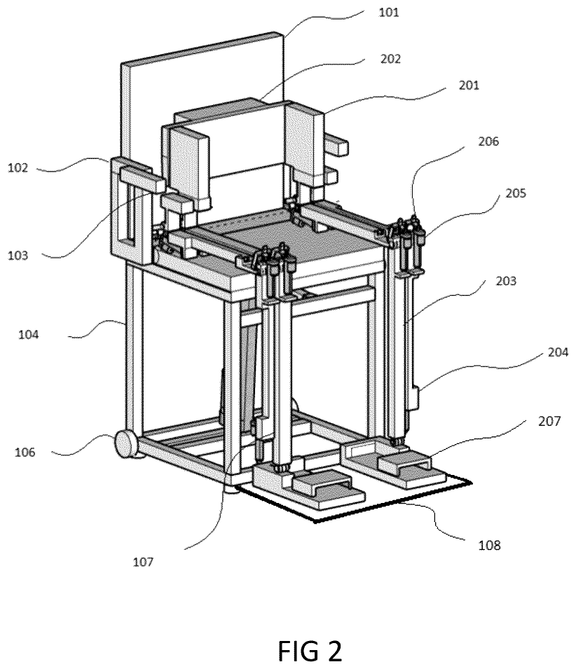

The wheelchair as shown in FIG. 1, may be converted to a stationary robotic chair, as shown in FIG. 2, by removing the front and back wheels. The back of the robotic chair (101) includes a wireless charger to charge the battery which may be located in the electronic box (202) of the exoskeleton (201). The charge may be done when the exoskeleton may be in storage position with auto-poles such as (204) and exoskeleton links such as (203) rest next to each other in a folded position by unlatching lock (206) and making the actuators such as (205) links of a 4-bar linkage which allows the large angular motion at the exoskeleton hip and knee. The HMI (Human Machine Interface) of the robotic chair may be attached to the extended arm support bar (103) which may be extended with respect to the arm support base (102). Wiring to the actuator from the battery may be routed within the robotic chair frame (104). For motion of the robotic chair from one location to another wheels (106) are being provided. The lock (206) may be unlatched only when the controller receives a signal that robotic chair seatbelt may be latched, and the bottoms of the auto-poles and their adjacent exoskeleton shank links are latched at a lock such as (107).

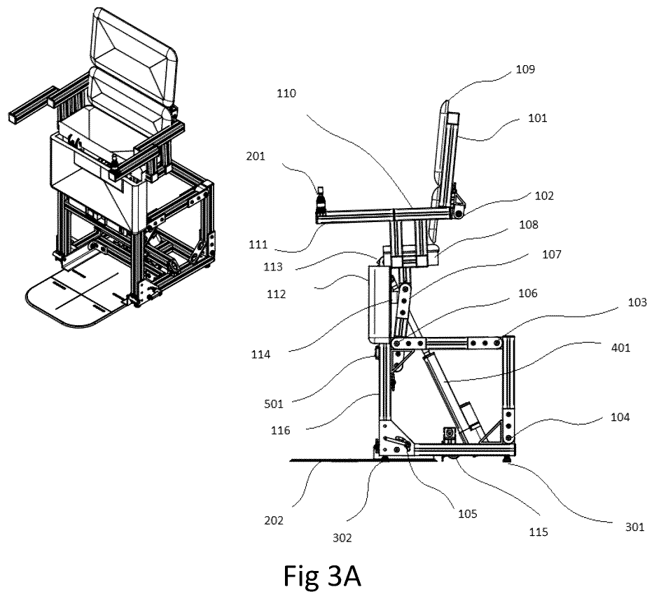

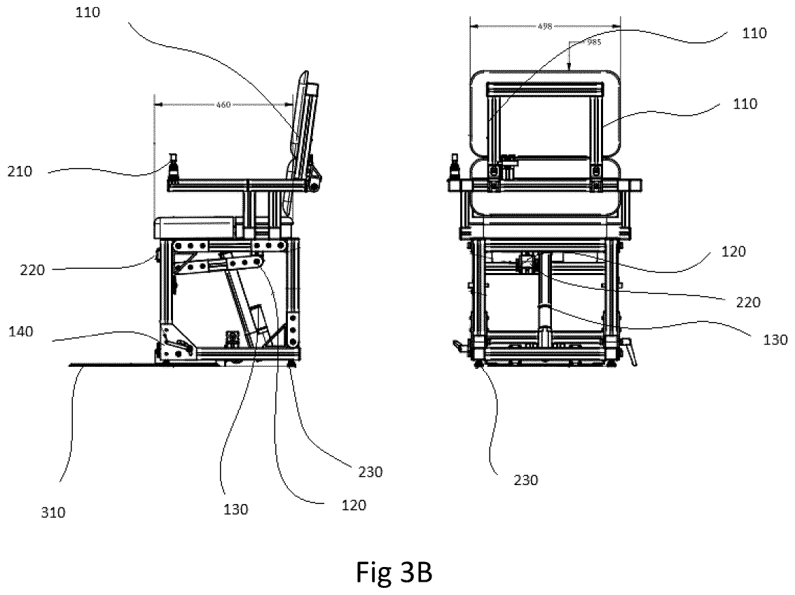

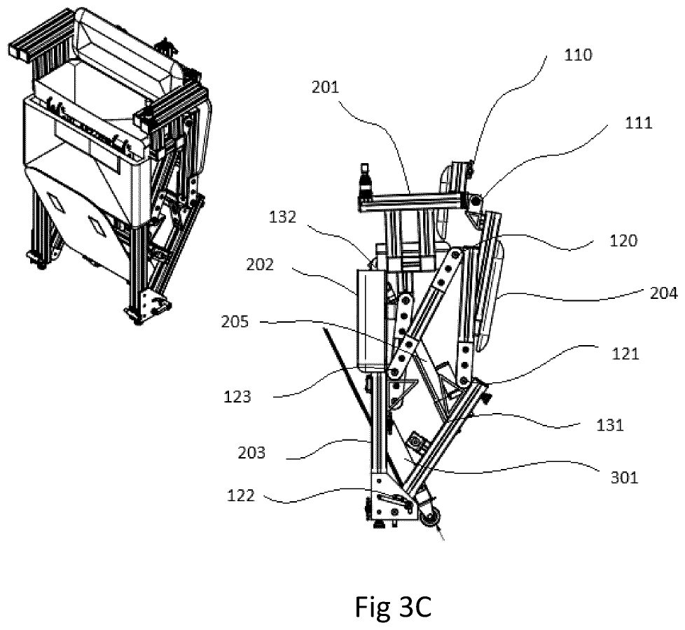

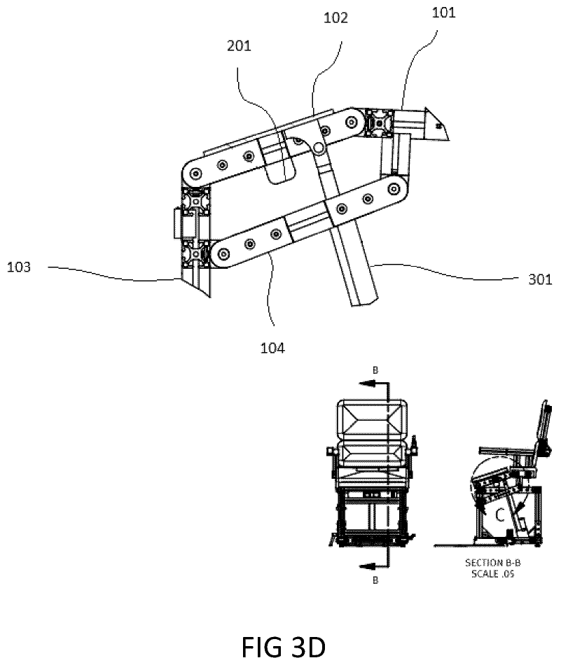

The robotic chair, which in some examples may be a complementary STS part of the exoskeleton system, may be positioned at sit, stand and in any position in between as well as in a folded position for storage and transport. In FIG. 3A the frame of the robotic chair, made of parts such as (101) may be shown in a stand position. The frame parts are connected with joints (102), (103), (104), (105), (106). These parts are mechanically locked at joint (105) with a positive locking pin. When the locking pin may be released, the robotic chair may fold by actuating the actuator (401). In addition, the front foot plate (202) may be folded at wheel axis (115). The robotic chair has a folded seat with 2 parts. Part 1 (112) may be supporting the user's thigh, and part 2, (108) supports the buttocks. Both parts are covered with comfort cushions. A 4-bar linkage including the two seat parts, the front structural link of the chair (116) and a connecting link (107) are designed to maintain the upper seat (108) parallel to the floor when the robotic chair may be in STS motion. This may provide user's sitting comfort during STS as well as higher security against slip. The motion of the robotic chair may be provided by an actuator (401) which drives the 4-bar linkage (107), (108), (112), and (116), during STS motion. A hard stop (114) may prevent the 4-bar linkage from exceeding its dead center position. The actuator may be pivoted at the lower base frame of the chair. The supporting arm part of the chair (110) may be a rigid part of the upper seat (108). An extended arm support part (111), with respect to fixed arm support part (110), provides the support for the joystick control to operate the robotic chair in STS motion. To maintain resistance to chair slip during STS motion, a foot plate (202) may be pivoted at joint (115) and resting on the floor. During STS the user feet are standing on the front plate (202) which resists both bending moments at front leg supports (302) and a slip to front or back. The robotic chair has 4 force sensors at the bottom of front leg tips (302) and back leg tips (301). During STS motion the controller (501) receives as an input the force reading from these sensors as well as actuator position and velocity to determine stability of the motion and outputs a control command to the actuator, to continue motion at maximum velocity, slow it down or stop. A RL program may advise the user how to change the seating posture for a safe ride.

The robotic chair, as shown in FIG. 3B, in its sit position, includes an adjustable back support (110). Back support adjustment may be provided to fit a comfortable user's posture. The bottom section of the chair seat may be actuated by a sit lift actuator with position feedback (130), which may be a link of a 4-bar linkage which maintains the top section of the seat in parallel orientation to the floor. The 4-bar linkage includes an articulating seat linkage (120) which connects the 2 other links of the 4-bar linkage, the front chair leg link, and the top seat section. The foldable chair links are locked with a fold locking device (140). At the bottom of the four chair legs there are leveling pads with load sensors (230). A foot plate with force sensors (310) provides resistance to chair motion during STS. The electrical control panel (220), with battery and AC power may be located in between the front chair legs. The HMI control joystick (210) may be located at the tip of the arm rest link.

For transportation and storage of the robotic chair it may be folded as shown in FIG. 3C. To unfold the chair the folding safety lock (122) may be released. The chair legs are the folded at the frame joints (120), (121), (122), (123). Folding may be done with the actuator (205) contracting the extension rod while being stationary at its upper joint (132) and lifting its lower joint (131). The seat back (204) folds separately at joint (111) after seat back safety lock (110) may be released. Front seat 202, front legs (203) and back seat assembly (201) are kept stationary during the folding motion, while feet plate assembly (301) may be being folded with the chair.

The 4-bar linkage which maintains the back seat (101) may be shown in FIG. 3D. The four links include the back seat assembly (101), The front seat (102), the front legs (103), and a connecting link (104). During STS motion, actuator (301) drives the front seat (102), while link (104) moves in parallel to link (102) and the vertical part of back seat assembly (101) moves in parallel to stationary link (103). The resulting motion maintains the back seat (101) closely parallel to the ground for comfort buttock support. Seat position safety stop (201) limits the upward motion of the chair, preventing the 4-bar linkage from passing the dead center point.

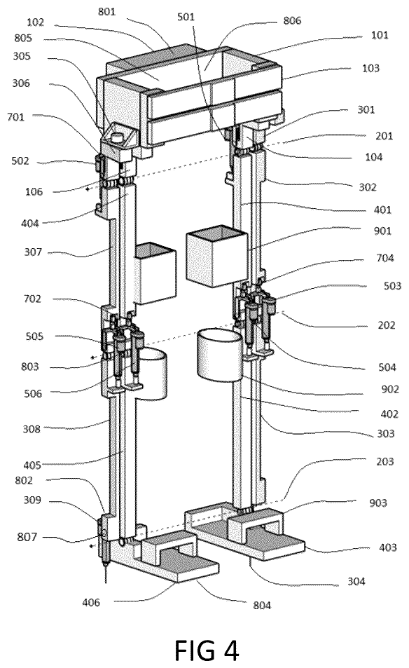

FIG. 4 illustrates the exoskeleton with 2 symmetric legs and 2 integrated, symmetric, auto-poles legs, in a stand-up position, including an upper frame (101), which acts as system base and strapped to the user's torso with straps (103). An electronic box (102) may be attached to the frame in the back for storing components such as battery, charger, I/O terminal, communication circuits, controller, amplifiers, and a 6 degrees of freedom (dof) gyro (801) for sensing acceleration in X,Y,Z directions, and angular velocities in pitch, yaw roll directions of the torso. Torso movements in 6 DOF may be used for user's monitoring of the exoskeleton motion. On each side of the frame there are two legs, one auto-pole leg and one exoskeleton leg. At the back of frame (101) there are force sensors (805), (806) for sensing the reactive load on the user's back for a comfort gait control.

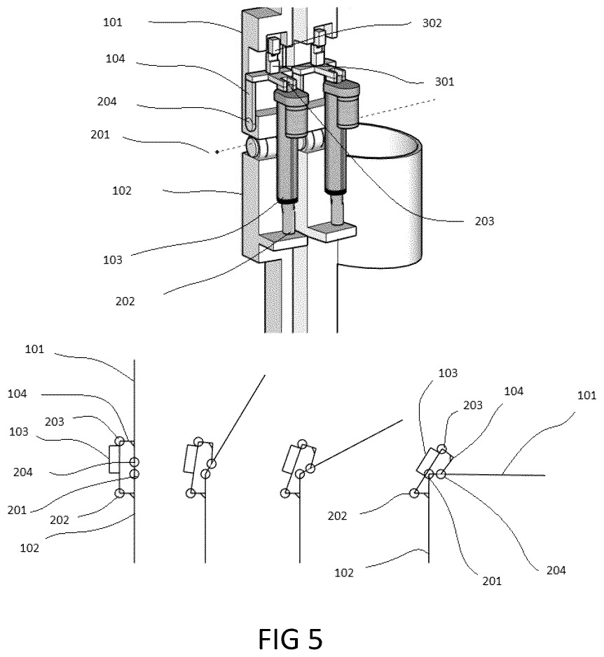

Each auto pole, as shown in FIG. 4, has one upper fixed link (301), (306) connected to the frame and two moving links, a middle link (302), (307) and a lower (303), (308). The upper auto pole links have fixed yaw axes actuated and secured either manually or by a motor or solenoid (305) with respect to the frame. The middle links are being actuated by the upper links with actuators such as (502) in pitch axis (201). The lower links are being actuated by linear axes (505), (503) at the middle links in pitch axis (202) which was rotated and locked by yaw axis (305). Each of the lower links has a linear actuator (309), (304) which increase the length of the auto poles. Each lower actuator for length control has a force sensor such as (802), which may be used for stability and safe gait control. The joints between the upper and middle links and between the middle and lower links have additional pitch axis, such as (702), which may be latched during gait motion, making the actuator and its two respective links a constraint “slider crank mechanism”, or be free for motion control for complex gaits and step climbing. The joint may be unlatched by a solenoid when the exoskeleton may be ready for an STS motion, or step climbing, making it a 4-bar linkage with thigh motion controlled by the robotic chair. The same type of latch mechanism, as detailed in FIG. 5, may be used in the 4 actuated pitch joints of the auto poles and the 4 actuated pitch joints of the exoskeleton leg. Alternatively, the auto pole pitch joints may be actuated by a direct drive rotary actuator.

Each, exoskeleton leg, as shown in FIG. 4, has one upper fixed link on each side connected to the frame (104) (106) and three moving links on each side, upper middle links (401), (404) and an upper, lower links (402), (405), and lower links (403), (406). The upper links are fixed with respect to the frame. The upper middle links are being actuated by the upper links in a pitch axis (201) by actuators such as (501), or by a direct rotary actuator. The upper lower links are being actuated by actuators (504), (506) about pitch axis (202), or by a direct rotary actuator, and the lower links are spring-loaded end effector shoes, which rotate with respect to the lower middle links about axis (203). All links are connected to each other with revolute joints. The joints between the upper and upper middle links, and between the upper middle links and the lower middle links of the legs are latched during gait motion, allowing the top and middle link actuators to move the middle and lower links respectively, during gait motion. These joints are unlatched, similar to the corresponding auto pole links, by solenoid, as shown in FIG. 5, when the exoskeleton may be ready for an STS motion.

As shown in FIG. 4, each exoskeleton link, including the main frame and the shoes have its own strap to connect it to the user limbs. The frame may be strapped to the user's torso (103), and possibly shoulders. The middle links of each leg are strapped to user's thighs such as (901), the bottom link may be strapped to the user's shanks, such as (902) and the shoes are strapped to the user's feet with straps such as (903). All straps have force sensors which are being used for monitoring user's comfort and making respective motion control changes.

For minimal over constrained motion and maximum comfort all links must have length adjustment, to fit the user's size and to have the exoskeleton hip, knee, and ankle joints (201), (202), (203) respectively as close as possible to corresponding user's joints.

For motion control each actuator, of the exoskeleton legs and the auto poles, has a position sensor, such as encoder or potentiometer. Each foot link has front and back force sensors (804), for gait stability control, like the auto pole force sensors such as (802). Before STS motion and before unlatching the STS locks, as shown in FIG. 5, upon robotic chair signal of latched seatbelt, the lower exoskeleton links are latched to the lower middle using a solenoid (807) to prevent side motion of the auto poles. In Sit position the robotic chair may be charging the battery of the exoskeleton.

The details of the pitch latch mechanism as described in FIG. 4, are shown in FIG. 5. The mechanism may be typical to hip joints of exoskeleton and auto poles legs, and to knee joints of exoskeleton and auto poles legs. Each typical mechanism includes two main links (101), (102), the actuator (103) and a connecting rod link (104). These links constitute a 4-bar linkage at 4 revolute joints (201), (202), (203) and (204). During gait motion, a latch (302), which may be fixed to link (101) may be engaged with lock (301) which may be fixed to link (104) and converts the 4-bar linkage to a fixed truss. During STS motion a solenoid above latch (302) disengage the lock (301) which converts the truss to a 4-bar linkage allowing the exoskeleton and its integrated poles to move from a stand position to a sit position. FIG. 5 also shows the respective kinematic diagram of the 4-bar linkage from stand position to sit position after the latch may be opened. The 4 bar linkages at the hip and knee joints of all 4 legs may be replaced by direct drive rotary actuators for combined gait, STS and step climbing motion.

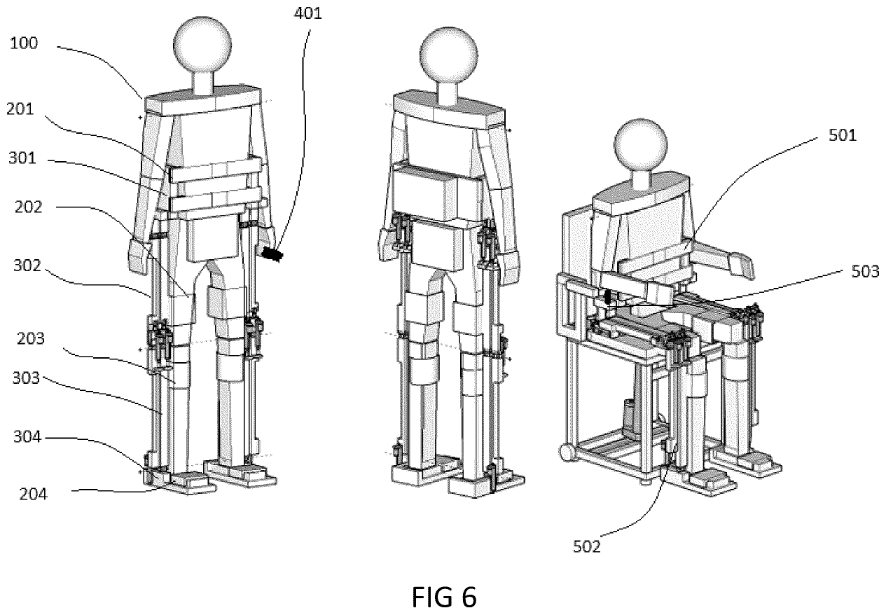

FIG. 6 illustrates the user (100) wearing the exoskeleton and auto poles frame (301) and links on both sides including 4 torso links which are fixed to the frame (301), 4 thigh links (302), 4 shank links (303) and 2 feet end effectors (304). When rising from sit to stand the user uses the exoskeleton straps on the two sides such as (201), (202), (203) and (204), for torso, thigh, shank, and foot respectively. Control on the robotic chair may be done by various means such as voice command or a joystick (503), Control of the exoskeleton may be done by various means such as torso motion, voice, switch, or handheld wireless HMI (401). When user may be in stand position ready for sitting down, the chair seat belt must be latched. The latch signal activates the solenoids, as explained in previous sections, and allow the exoskeleton and auto poles links to bend. In addition, the seatbelt signal activates the latch (502) between the bottom links of the auto poles and their nearby shank links of the exoskeleton to restrict their relative motion to each other which may interfere with the STS motion of the driving chair.

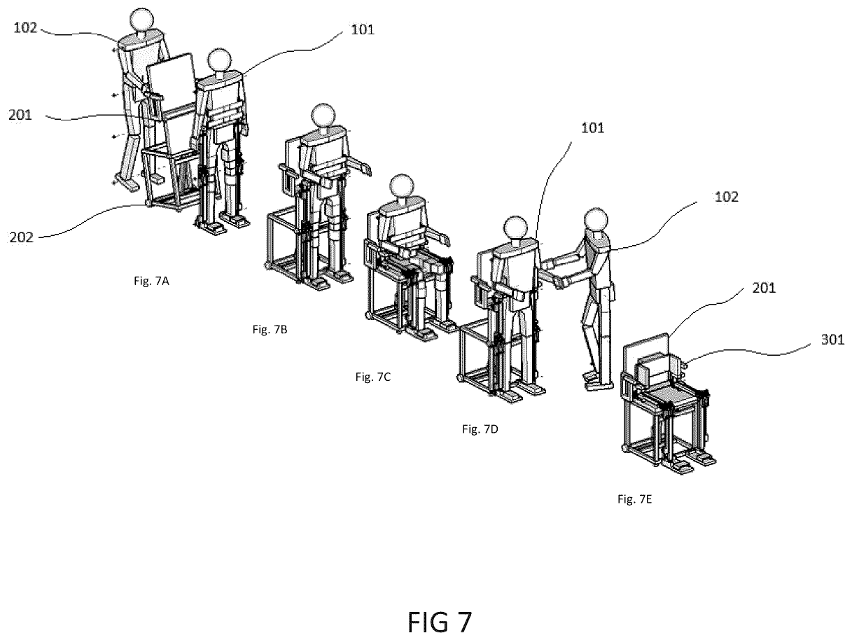

FIG. 7A demonstrates a possible process of a human (102) assisting a handicapped user (101) to reach the STS position of the robotic chair (201). Positioning the robotic chair near the user could be done with wheels (202). When the user may be ready to sit, as shown in FIG. 7B the chair seat belt may be latched. Latching the seatbelt sends a signal to the robotic chair to start the stand to sit motion, unlatching the exoskeleton links and latching the auto poles bottom links with the nearby shank link of the exoskeleton. The down motion may be actuated by a voice commend, button or a joystick. Once seated, as shown in FIG. 7C, the user can open the seat belt and unstrap the exoskeleton bands before standing up. Before standing without the exoskeleton the chair seatbelt must be latched again to initiate the sit to stand motion. After standing up without an exoskeleton, as shown in FIG. 7D, it may be expected that a supporting human (102) may assist the user (101) in getting to the desired location without the exoskeleton. After the user leaves the robotic chair, the exoskeleton may be rigidly connected to the robotic chair, as shown in FIG. 7E, getting ready for the next stand to sit and gait motion. During this time the exoskeleton battery may be being charged. When the user may be ready for another gait, the robotic chair in FIG. 7E and the exoskeleton rise to stand position, the user may be being escorted by a human support (102) to the exoskeleton dress up, in a stand position, as shown in FIG. 7D, or if preferred, dress up the exoskeleton in a sit position as shown in FIG. 3. Once dressed in sit position the robotic chair rises to a stand position, as shown in FIG. 7B and the user (101) may be ready for an independent gait, as shown in FIG. 7A.

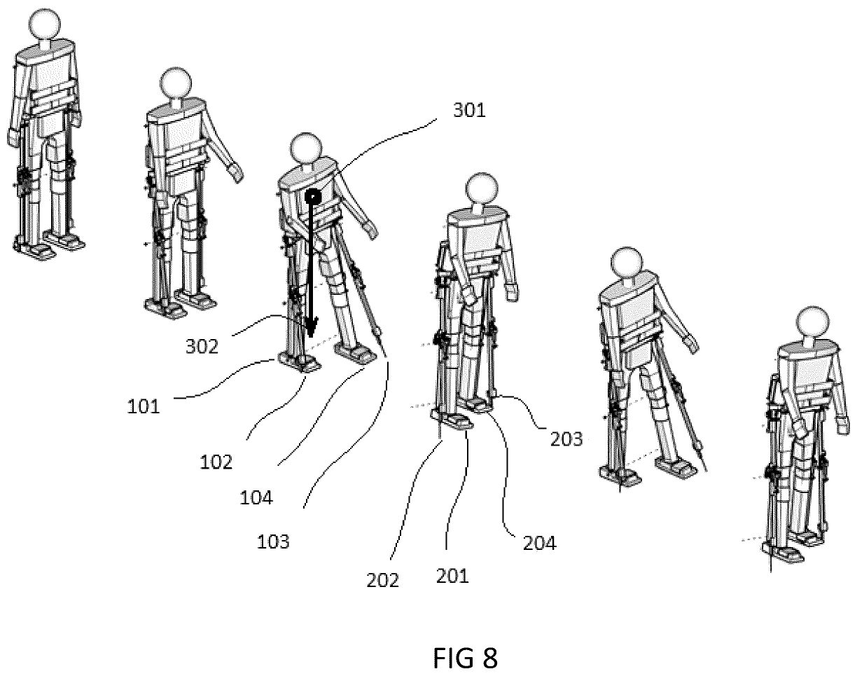

There are several gait cycles options, which may be used to best fit the characteristics of handicapped persons, with the objective to maximize safety, minimize training time, maximize usage comfort, and minimize energy consumption. These conflicting characteristics may be optimized using AI, Reinforcement Learning (RL), technology. The characteristics of the user may include parameters such as handicap type, limbs, time it exists, severity level, age, gender, weight, and height. The choice of possible gait options for consideration may be prescribed by a physical therapy professional with reference to accumulated data of successful experiences, using advanced technology such as Supervised Learning (SL) technology tools in Data Clouds. FIG. 8 illustrates a gait option, out of several possible ones, where only the hips are actuated with the knees being kept straight. For this option one auto-pole (103) moves forward and the two poles (103), (102) and one stance foot (101) serve as the body support. The body center of gravity (cg), (301), may be leaning by the user, after training, to be within the triangular safety zone and close to the center of pressure (COP) of support points (101), (102) and (103). Next, swinging forward the leg (104) on the side of the forward pole (103), while the projection (302) of the of body weight cg (301) to the ground may be close to the COP near the stance foot (101) and its nearby auto-pole (102). When the swinging leg (104) reaches the ground at (204), the new safety region becomes the triangle between (204), (203) and (101), where the COP may be near (204) and (203). The user leans the body cg close to the new COP and pole (102) moves forward to its new position (202). Now, the new supporting points are (203), (204) and (202) and foot (101) can move forward to its new position (201 to finish the step cycle and start a new one.

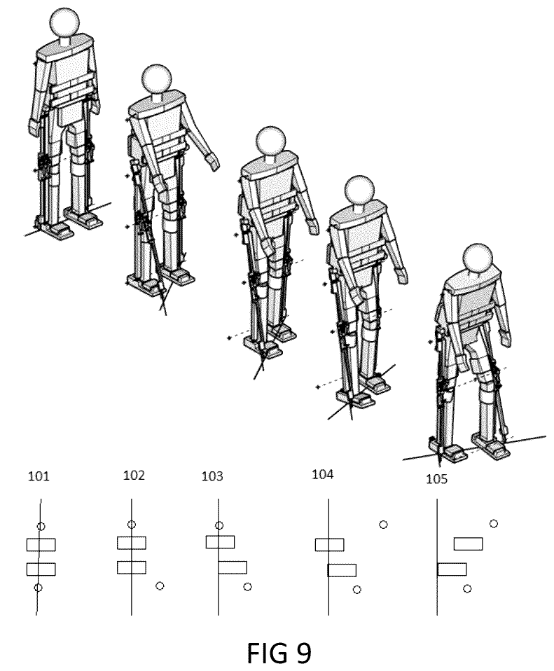

FIG. 9 shows another gait cycle, where both thigh and shank are actuated, while the two exoskeleton legs and the two auto-poles legs take turn in safely supporting the moving weight load. This gait has the advantage of requiring less sideways bending by the user of the torso towards the stance foot and pole, as needed in the gait option of FIG. 8, when only the hip may be actuated, to clear the swing leg off the ground. The example in this gait cycle starts when user may be standing on two feet with the two auto poles legs on their sides (101). Next, one pole leg moves forward with the 2 stationary feet and one stationary pole leg serving as stability supporting points (102). Next one-foot swings forward with the other foot and two pole legs serving as the new supporting points (103). Next, the second pole leg moves forward, when the two feet and one pole support the loads (104). Finally, the second exoskeleton leg swings forward where the two auto pole legs and the other exoskeleton leg support its move (105). To summarize, before any exoskeleton leg or an auto pole leg swings off the ground, the other three units of exoskeleton legs and auto pole legs, are in contact with the ground forming the gait balance safety zone. The COP may be the point where all the supporting loads are balanced, and the objective of a safe gait cycle may be to assure that the projection of the moving body weight cg, as controlled by the user after training, may be as close as possible to the COP. This objective may be the basis of a balanced, safe, STS, gait and step climbing motion which the motion controller controls.

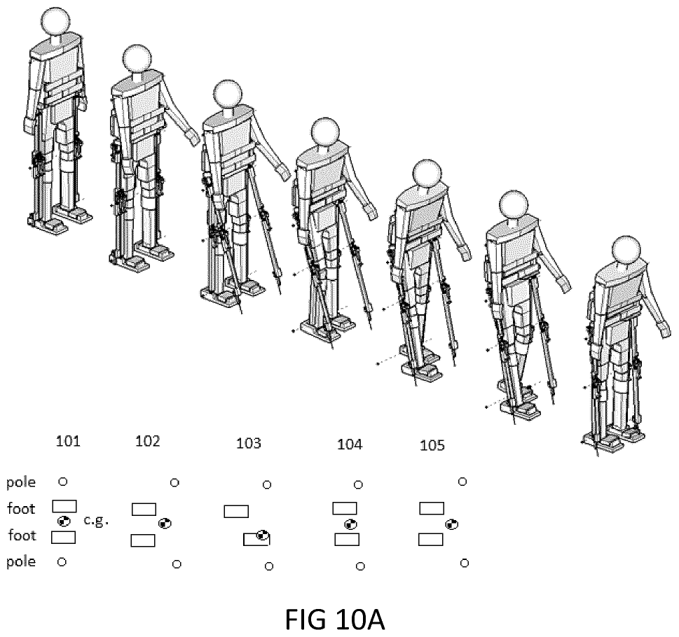

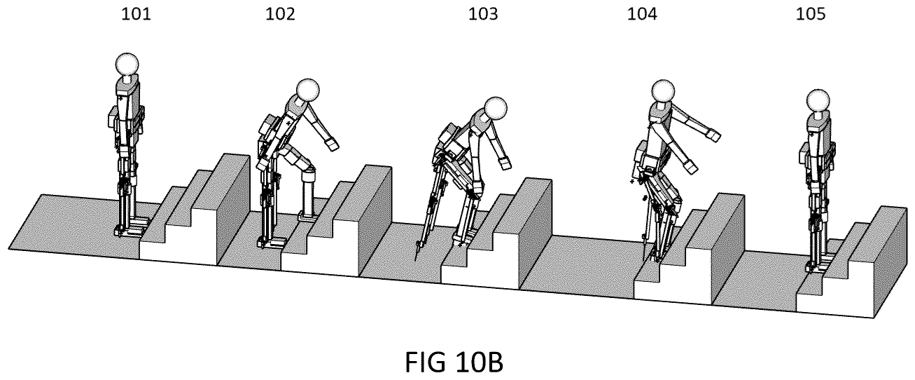

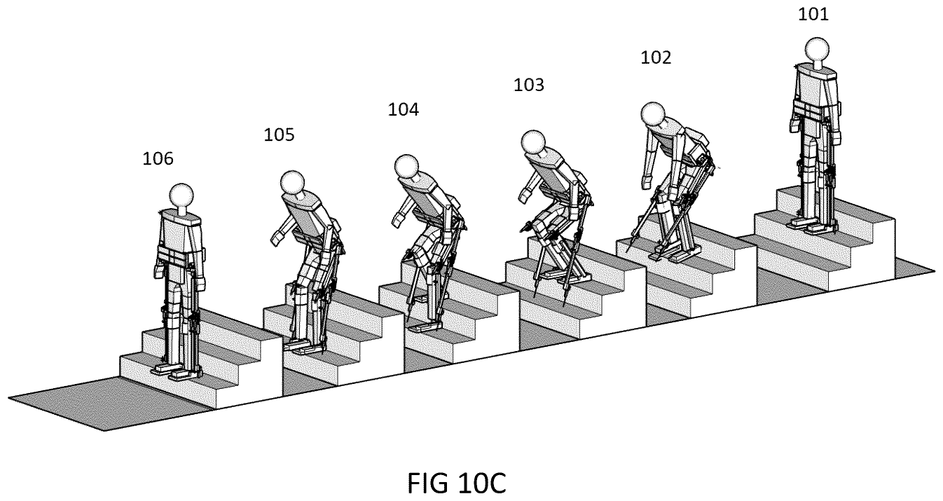

FIG. 10A illustrates yet another gait option, where the cycle starts with the user standing on two feet (101) and the two auto poles legs are swinging forward (102). The user then leans forward, one exoskeleton leg (103) swings forward while the user, after training, may be keeping the body e.g. between the two stance poles and the stance foot. Once the swing foot reaches its destination it becomes the new stance foot with the 2 stance, auto pole legs. The foot that started as the stance foot may be swinging forward to complete the cycle (104) which duplicates (101). The gait cycle then repeats itself with the next move of (105) which duplicates (102). This gait may be applied to either hip and shank actuated motion or hips only. In addition, for increased balance the simultaneous swing of the two auto pole legs forward can slow down for higher safety and move one auto pole leg at a time. The choice between slower or faster cycle may depend on the user's specific needs, as prescribed by a physical therapy specialist, and possibly supported by AI/ML data of successful results with other users.

FIG. 10B illustrates a step climbing motion, starting at a straight system posture (101). Next step (102) the user leans forward while the two auto pole legs and one exoskeleton leg adjust their angles with respect to the torso base and maintain ground support while the other exoskeleton leg climbs the step. When the two exoskeleton legs complete their step climb (103), they serve as a support for one of the auto pole legs to climb the step. Then, the three legs that completed the step climb (104) serve as a support for the last auto pole leg to finish the climb with a straight system posture (105), ready to repeat the process in the next step.

FIG. 10C shows a downstairs motion. Starting with a straight posture on a step (101) the exoskeleton legs then bend with the torso leaning forward (102). The auto-pole legs pitch forward and engage the lower step (103). With two auto pole legs engaging the lower step floor and one exoskeleton foot serving as a balancing support, one of the exoskeleton legs moves down the step (104), followed by the second leg (105). The legs and torso than return to a straight posture ready to repeat the process in the next step.

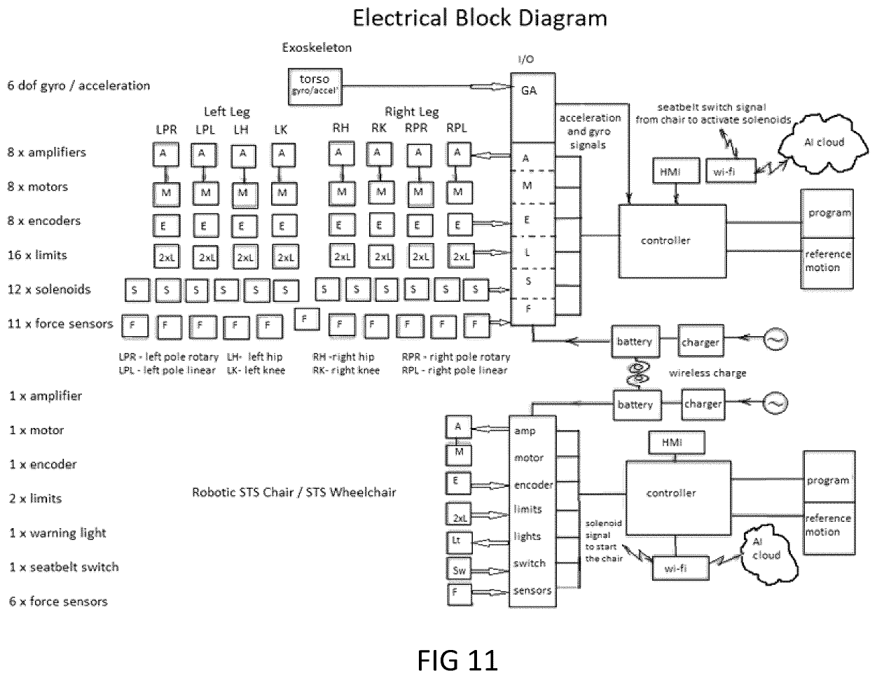

FIG. 11 shows an example of the electrical block diagram of the exoskeleton and robotic chair system, which may be presented in the present disclosure. For the exoskeleton, the block diagram shows 8 amplifiers to drive the motors of pitch and extension axes of each auto-pole leg, and the hip and knee joints of each exoskeleton leg. Also shown are 8 motors, driven by their respective amplifiers, and their associated 8 encoders for position feedback. Each one of these 8 axes has 2 limit switches, one for minimum and one for maximal travel. The diagram also shows 12 solenoids. 8 for the auto pole legs and 4 for the exoskeleton legs. Each auto pole leg has 4 solenoids—one for yaw axis, one for locking it with its nearby exoskeleton leg during STS, and two for the hip and knee for unlocking their associated 4-bar linkage during STS. Each exoskeleton leg has two solenoids, like the auto poles, for the hip and knee to unlock the 4-bar linkage during STS. The system has 11 force sensor sets. One force sensor set in each exoskeleton foot, including front and back, for ground reaction force measurement. One force sensor set for each auto pole leg for ground reaction force measurement, three force sensor sets, one for each exoskeleton strap including thigh, shank and foot, and one sensor set for the torso and its associated straps for body reaction forces measurements. Also shown in FIG. 11 may be the Shank Gyro (SG), which may be mounted at the back of the shank support, including 3D accelerometer feedback and 3D gyro feedback for measurements of posture control movements by the user. The exoskeleton battery may be charged with either an AC charger or from the robotic chair battery through a wireless charger. The controller has a wi-fi transmitter of signals to a Cloud for data storage, monitoring, and controller parameters updates. The exoskeleton controller also has a wi-fi connection to the robotic chair controller for exchanging signals during STS interactive motion. The controller may be connected to an I/O circuit which may be in the electronic box at the back of the supportive torso frame. Software within the controller may be diploid by an external computing system such as a laptop or PC which runs the simulations and updates the controller parameters. HMI may be available as speech recognition, frame mounted, joystick and buttons and a wireless hand-held switch box.

FIG. 11 also shows the block diagram of the robotic chair, or a manually driven robotic wheelchair, which stores the exoskeleton and provides the STS motion for the exoskeleton user. The robotic chair has one actuator, for the knee joint, with one motor and encoder feedback. The axis may be driven by an amplifier and has 2 limits for min/max travel. Seatbelt switch may be being used to assure that user may be securely belted to the chair for STS motion. Four force sensors, one for each leg, and 2 sensors, front and back, for the front feet plate of the stationary chair, are used for force reaction feedback during STS motion. HMI may be driven by voice command, push buttons and/or joystick switch. Lights are being used for warning, feedback, and monitoring signals for posture corrective action by the user. Wi Fi may be being used to communicate with the exoskeleton during STS motion as well as for communication with a Cloud for data storage and parameters updates. The robotic chair battery and its AC charger are being used to charge the exoskeleton battery, when mounted on the chair by using a wireless charger. The robotic chair controller may be connected to an external programming controller such as lap top or PC.

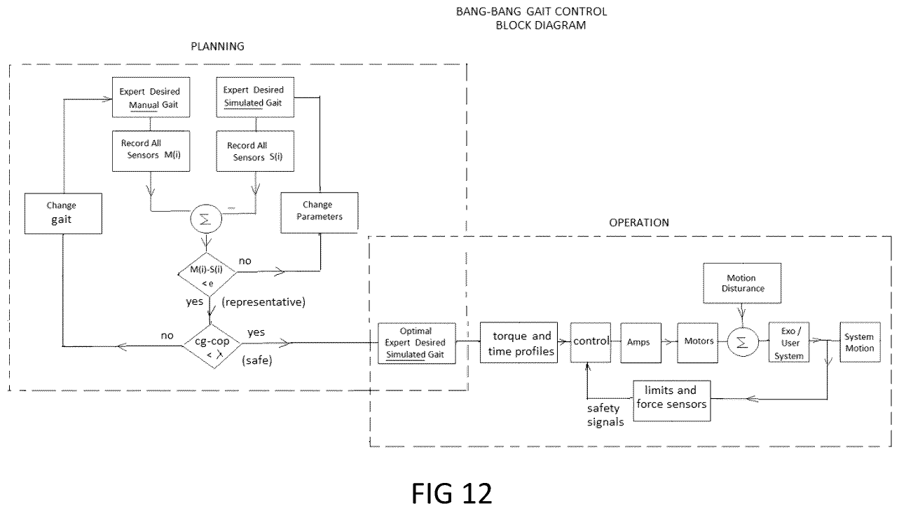

FIG. 12 illustrates a motion control block diagram for the exoskeleton. The diagram includes 2 main parts including planning and operation.

The objective of the planning part in FIG. 12 may be to define the desired gait profile for the exoskeleton. The planning process includes two desired gait profiles. One gait profile may be determined manually using an unpowered exoskeleton with sensors. The manual gait profile may be determined by a healthy expert user, for the desired rehabilitation, curative, augmented or assistive objective, for which all sensors including encoders, gyro, accelerometer, and force sensors are being recorded as a function of time. The simulated part of the motion profile includes a dynamic model of the system environment, including the exoskeleton auto poles and the user. The dynamic model may be driven as an input by the desired gait or step climbing profile, as measured in the manual test, and outputs the resulting force reactions. The resulting simulated force reactions are compared with their equivalent results in the manual test. The difference between the results may be the simulation error. If the error may be greater than a set limit the simulated model parameters are being changed to better represent the real environment as tested. If all sensor errors are within their error limits, the simulation may be accepted to be used as a desired reference for the motion controller and for AI/RL parameter optimization. The next step may be checking the gait safety by assuring that the e.g. may be close to the center of pressure (cop) during the entire gait cycle. If the simulation concludes that the gait cycle may be not safe the process repeats itself with an improved manual gait cycle test. If the process may be safe the kinematic model becomes the optimized desired reference gait function for the controller and the corresponding dynamic model may be used for AI/RL simulations.

The objective of the operation part, as shown in FIG. 12, may be to control the exoskeleton motion with a bang/bang (on/off) controller. FIG. 12 shows the block diagram of the actual operation, where the reference kinematic cycle, as derived in the planning phase, may be converted in the simulator to optimal max/min torque to the actuators as a function of time for each axis to best result in the desired motion profile and force reactions. The torque and time sets are then used to control each axis. This control function may be intended to provide the desired gait motion at a minimal energy at a possible cost of a low accuracy, which may be approved by a medical specialist for a safe therapy or rehabilitation treatment. As feedback, to assure that random, nonlinear actions are within the expected safe region, the limits of all axes and the force sensors are being analyzed in real time and may stop, slow down the motion or sound a warning signal to direct the user in the right posture direction changes as may be needed.

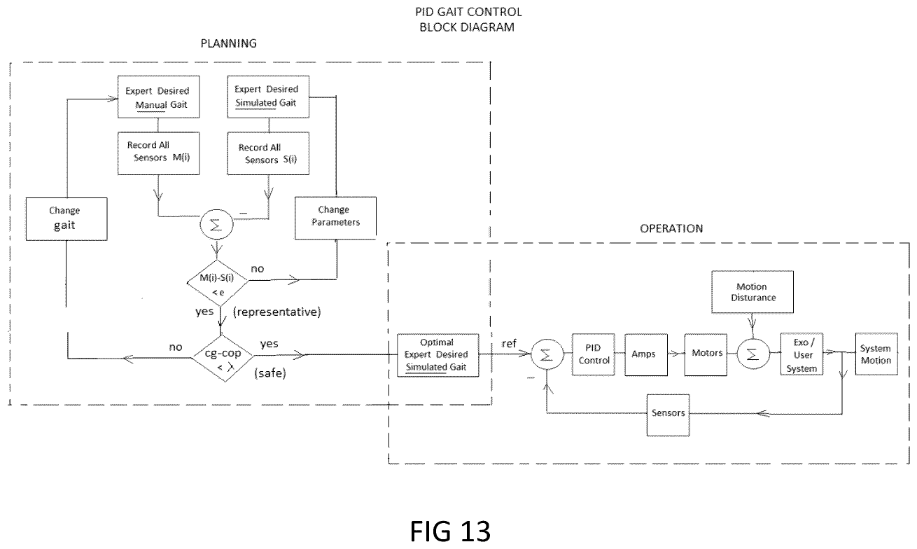

FIG. 13 shows a PID block diagram with two sections. A similar planning section as in 12 and a PID block diagram for the operation section. The PID controller receives an error signal, which may be a measure of the difference between the desired links positions as a function of time, as determined in the planning phase and the actual position signals as being fed back by the sensors. The torques to the motors are then provided by the amplifiers which receive torque commands according to the PID parameters (proportional, derivative, and integral of the position errors). The controller also receives real time feedback of the force sensors, gyro and accelerometer sensors reading, and use these feedback signal to sense posture position, initiate the gait or step climbing cycle, monitor safety, and provide feedback signals.

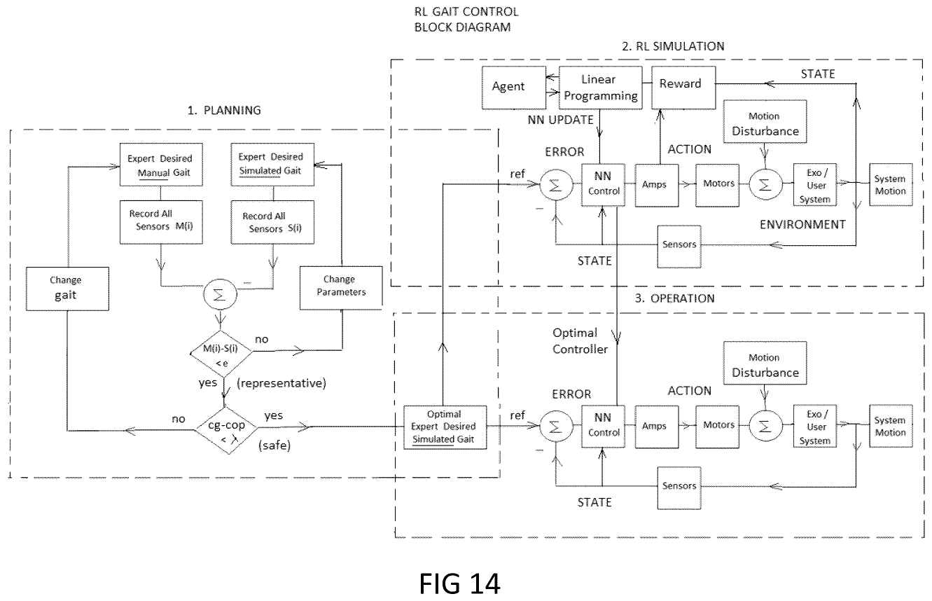

FIG. 14 shows a RL block diagram of the exoskeleton with 2 auto-poles legs. The diagram may be shown in three sections.

The planning section may be the same as described in FIGS. 12 and 13, providing a desired reference kinematic and force profiles of each actuated exoskeleton joint and auto pole axis for the desired gait or step climbing motion.

The second section may be a dynamic RL model, which simulates the exoskeleton system, with the dynamic model of the simulation which was used in the planning phase, including the user's inertia and random disturbances. In addition, the RL simulation uses a Neural Network (NN) controller to transform the state of the environment, as sensed by the sensors and the error between the target joint positions and actual positions, and output the commanding torques to the actuators' motors. The NN includes hundreds of weight parameters and their related biases, which are being optimized by maximizing a total reward function for a given set of states and actions. An estimated total reward for the entire process, such as for minimal error, minimal energy consumption, maximum safety with a minimal distance between CG and COP, and maximal comfort with minimal reaction forces at selected strapping bands, may be being provided by a Critic program. At the same time, the actual reward for the same set of states and actions may be provided by the Actor. A RL Agent may be then updating the NN parameters, using Bellman equation and dynamic programming, to minimize the difference between the total estimated rewards, as predicted by the Critic, and the actual updated estimated reward as result of the Actor which converts states to actions.

After the Critic and the Actor estimates converge, the final NN may be converted to a program, such as C++, and being deployed to run as a standalone RL controller, as shown in the operation section of the block diagram of FIG. 14.

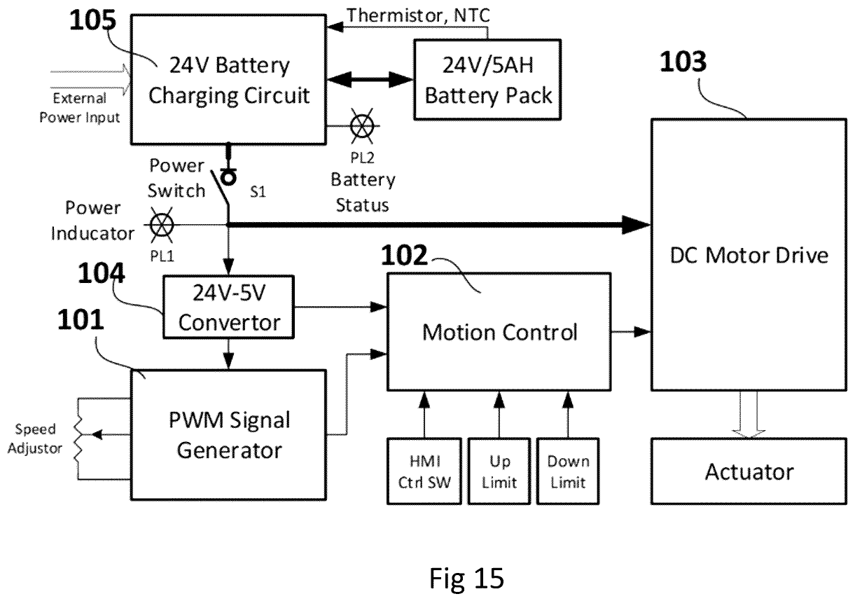

FIG. 15 shows an example of control board schematics for the standalone STS robotic chair, including the functions of 24V battery charging circuit (105), 24V/5V linear regulator (104), PWM signal generator (101), motion control (102), and DC motor drive (103). Additionally, the circuit diagram shows a DC power input jack, battery status indicator, power switch, power indicator and connectors for battery pack and thermal sensor, limit switches, control switch and actuator.

All control circuits, as shown in FIG. 15, are included in a PCB assembly which provides functions of 24V battery charging circuit, 24V/SAH, battery pack, 24V/5V linear regulator, PWM signal generator, motion control, DC motor drive, DC power input jack, and battery status

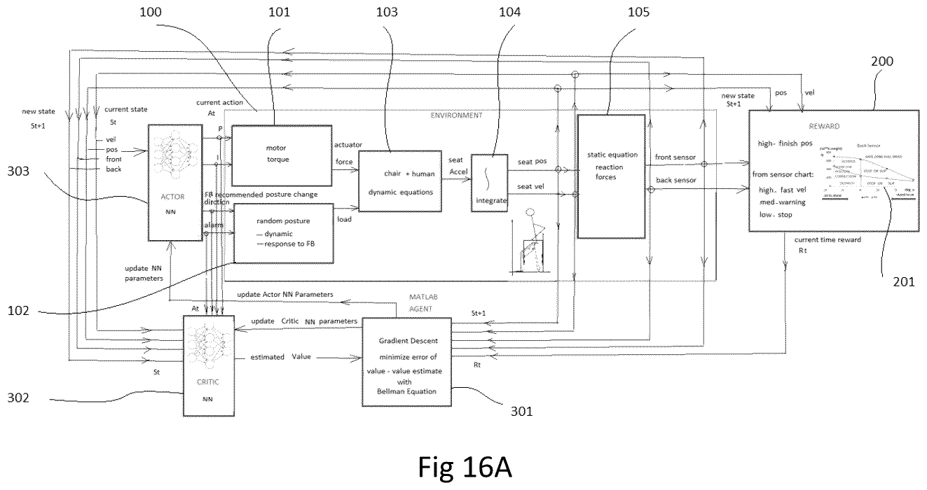

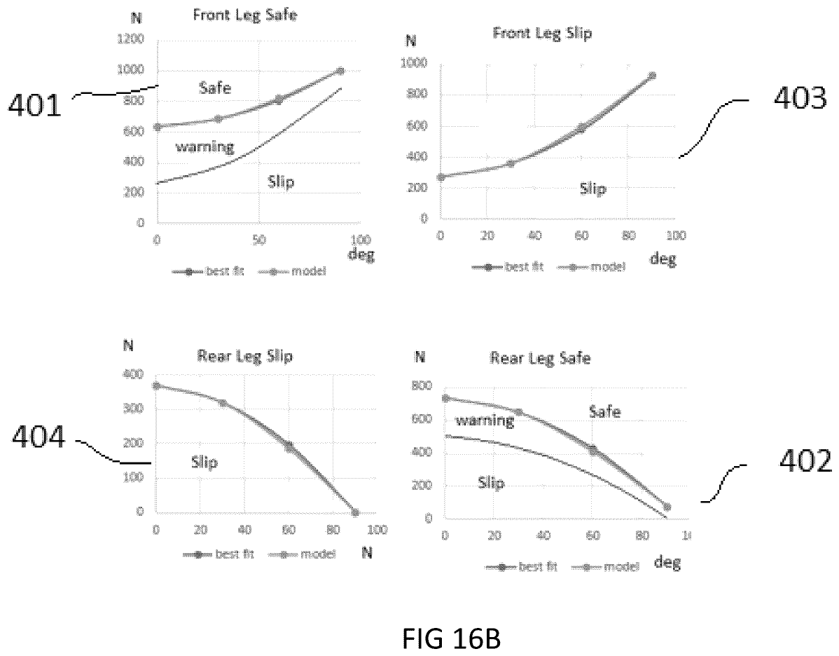

FIG. 16A shows an example of a RL block diagram for a standalone robotic STS chair. The example shows the RL environment (100) which includes the actuator and its motor (101), the chair which they are acting on with a random human load (103), the mathematical integral conversion of the resulting chair acceleration to chair velocity and position (104) and the static or dynamic model (105) which determines the reaction loads at the chair legs, as measured by the front and back load sensors. These outputs are considered the State of the environment which are being fed into the Reward function (200). The Reward function may be a measure how much the resulting action of the Actor, meet the performance objectives of the environment. The better the fit the higher may be the Reward. The State and the Reward of the Actor action enter the RL Agent (301).

The environment (100) may be being acted upon by an Actor which received in the Neural Network (NN) controller (303) an input of the system State, including chair position and chair velocity as well as front and back load cell readings, and outputs the actions on the environment which includes in this case the control parameters to the actuator motor, as well as feedback signals to the user for recommended posture changes to yield a safer ride.

At the same time the present State, and its resulting Action enter a Critic (302), which estimates the total Reward of the entire STS process. The critic estimate enters the Agent (301). The objective of the Agent (301) may be to minimize the error between the estimated of total process reward by the Critic and the updated total process reward estimate based on the Actor's last Action. The Agent does it using dynamic programming which changes the NN parameters, such that the difference between the Actor and Critic estimates of total process Reward may be minimized. The parameters of the NN are being changed after each simulated iteration until the error may be lower than a preset value. After the iterations converge to an error less than a preset value, the Agent NN may be deployed into the motion controller of the Robotic chair.

The Reward function (200) in this example may be high for completing an STS motion in minimal time and providing high reward for being in a safe region. A lower reward, which may also stop the chair, may be for being in an unsafe region and medium rewards may be provided for being in a warning region which requires a posture change by the user. The safety regions are provided as a function of seat position by curves 201. These Safe and Slip curves may be generated by testing or by simulation, and then converted to mathematical functions using best fit methods. Examples of best fit functions are shown in FIG. 16B (401), 403) for front chair legs and (402), (404) for rear legs.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An exoskeleton system for gait, sit to stand (STS) and step climbing assistive motion, the exoskeleton system comprising:
a torso frame;
four articulated robotic chain legs, including two exoskeleton chain legs and two auto-pole chain legs, which are connected to the torso frame on one end and touch the ground in their other end; and
a motion controller to control the four articulated robotic chain legs, with a user interface, and interact with an assistive stationary robotic chair or a wheelchair for storage, dressing, STS and rest.

2. The exoskeleton system of claim 1, wherein each exoskeleton chain leg of the two exoskeleton chain legs has four links including, an exoskeleton foot link, an exoskeleton shank link, an exoskeleton thigh link, and an exoskeleton torso link, and
wherein each auto-pole chain leg of the two auto-pole chain legs has three links including an auto-pole shank link, an auto-pole thigh link, and an auto-pole torso link.

3. The exoskeleton system of claim 2, wherein the exoskeleton foot link has force sensors and is connected with a spring-loaded, revolute, pitch, ankle joint, to the exoskeleton shank link,
wherein the exoskeleton shank link is connected to the exoskeleton thigh link at a revolute, pitch, knee joint, and actuated by a rotary or linear actuator, which is mounted on the exoskeleton thigh link,
wherein the exoskeleton thigh link is connected to the exoskeleton torso link at a revolute, pitch, hip joint, and actuated by a rotary or a linear actuator, which is mounted on the exoskeleton torso link, and
wherein the exoskeleton torso link is fixed to the torso frame.

4. The exoskeleton system of claim 3, wherein the exoskeleton shank link and the exoskeleton thigh link have an adjustable length to fit a shank and a thigh of a user.

5. The exoskeleton system of claim 2, wherein the auto-pole shank link has a linear actuator mounted to the auto-pole shank link, driving a shaft which is in contact with the ground, with a force sensor to measure ground reaction force,
wherein the auto-pole shank link is connected to the auto-pole thigh link with a revolute, pitch, knee joint and actuated by a rotary or linear actuator, which is mounted to the auto-pole thigh link,
wherein the auto-pole thigh link is connected to the auto-pole torso link by a revolute, pitch, hip joint and actuated by a rotary or a linear actuator which is mounted to the auto-pole torso link, and
wherein the auto-pole torso link is connected to the torso frame with a revolute, yaw, joint and actuated manually or by a rotary or a linear actuator which is mounted to the torso frame.

6. The exoskeleton system of claim 5, wherein the auto-pole shank link and the auto-pole thigh link have an adjustable length to fit a shank and a thigh length of the exoskeleton chain legs.

7. The exoskeleton system of claim 2, wherein each of the links has a strap or a security belt to a respective body part of a user with force sensors attached to the links to sense the reaction of dynamic and static loads.

8. The exoskeleton system of claim 1, wherein the torso frame is adjustable to a torso size of a user, with an electronic box, and a user control box mounted to the torso frame, and
wherein the torso frame includes one or more of hand sensors, voice control sensors, switches, buttons, motion control circuits, input/output terminals, power supply, battery, linear motion sensors, rotary motion sensors, force sensors, or wireless communication circuitry and antenna, securely mounted to the torso frame with the user control box that is accessible to the user's hands.

9. The exoskeleton system of claim 8, wherein the motion controller is within the electronic box, with Artificial Intelligence (AI)/Reinforcement Learning (RL), proportional-integral-derivative (PID) and Bang-Bang algorithms to sense sensors signals, user command and robotic chair signal and command motors of controlled joints of the exoskeleton system, independently or in synchronization with motion of the assistive stationary robotic chair.

10. A robotic chair comprising:
a frame with four legs with force sensors at their bottom, which are adjustable to an approximate length to a shank of a user;
a seat with a front link supporting thighs of the user, and a back link supporting the buttocks of the user,
wherein the back link has a vertical plate supporting the back of the user, and horizontal arms supporting the hands of the user during a STS motion,
wherein the front link and the back link are connected to each other with a revolute, pitch, joint,
wherein the front link is also connected to the frame by a third link with a revolute, pitch, joint, and the back link is connected on its other hand to a fourth link that is approximately parallel to the front link, and connected to the back link with a revolute pitch joint and adjusted in length to fit the user, and
wherein the front link, the back link, the third link and the fourth link constitute a four-bar linkage that maintains the seat approximately parallel to the ground during the STS motion.

11. The robotic chair of claim 10, wherein the front link or the back link of the seat is actuated by a rotary or a linear actuator which is mounted to the frame to produce sit to stand and stand to sit motion for the user and an exoskeleton system that interacts with the robotic chair.

12. The robotic chair of claim 10, wherein the robotic chair further comprises a four-bar linkage to maintain the back link of the seat approximately parallel to the ground to support the buttocks of the user.

13. The robotic chair of claim 10, wherein the robotic chair further comprises an electronic box, and a user control box mounted to the frame, and
wherein the robotic chair further comprises one or more of hand sensors, voice control sensors, switches, buttons, motion control circuits, input/output terminals, power supply, battery, linear motion sensors, rotary motion sensors, force sensors, or wireless communication circuitry and antenna, securely mounted to the robotic chair with the user control box that is accessible to the user's hands.

14. The robotic chair of claim 13, wherein the robotic chair further comprises a motion controller mounted within the electronic box, with AI/RL, PID and Bang-Bang algorithms to sense the sensors signals, user's command and exoskeleton signals and command the motors of the controlled joint of the robotic chair in claim 1, independently or in synchronization with the motion of an exoskeleton system that interacts with the robotic chair.

15. A system for gait, sit to stand (STS) and step climbing assistive motion, the system comprising:
an exoskeleton system comprising:
a torso frame;
four articulated robotic chain legs, including two exoskeleton chain legs and two auto-pole chain legs, which are connected to the torso frame on one end and touch the ground in their other end; and
a motion controller to control the four articulated robotic chain legs, with a user interface; and
an assistive stationary robotic chair or a wheelchair to interact with the exoskeleton system for storage, dressing, STS and rest.

16. The system of claim 15, wherein the assistive stationary robotic chair includes:
stationary chair legs; and
a front standing plate including force sensors attached to a front of the stationary chair legs to resist motion when loaded by the weight of a user.

17. The system of claim 15, wherein the assistive stationary robotic chair or the wheelchair, includes:
a chair controller; and
a torso strap which signals the chair controller readiness for motion.

18. The system of claim 15, wherein the assistive stationary robotic chair or the wheelchair includes a wireless battery charger for the exoskeleton system while sitting on the assistive stationary robotic chair or the wheelchair.

19. The system of claim 15, wherein the assistive stationary robotic chair or the wheelchair includes a folding option of at least one of a foot plate, a frame, seat, a seat back or legs for storage and shipping.

20. A chain leg comprising:
leg links connected to one another by with joints,
wherein each joint by which two of the leg links are connected includes means for unlocking motion of an actuator by a clutch when a rotary actuator is used to drive the joint, or by a four-bar linkage when a linear actuator is used to drive the joint, and the four-bar linkage includes the actuator, the two of the leg links and an additional connecting rod link which is locked during actuator-driven motion, and
wherein the chain leg is an exoskeleton chain leg or a robotic auto-pole chain leg.

21. The chain leg of claim 20, wherein the connecting rod of the four-bar linkage is locked to one of the leg links with a spring-loaded pin which is unlatched with a solenoid.
